(19) United States
(12) Patent Application Publication
(10) Pub. No.: US 2009/0171989 A1
(43) Pub. Date: Jul. 2, 2009

(54) Identity Data Model Broker

(76) Inventors: Gregory T. Byrd, Raleigh, NC (US); Michael Mcintosh, Clifton, NJ (US); Anthony J. Nadalin, Austin, TX (US); Nataraj Nagaratnam, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/966,541

(22) Filed: Dec. 28, 2007

(51) Int. Cl. G06F 17/30

(52) U.S. Cl. 707/100; 707/E17.044

(57) ABSTRACT

A method, system and computer program product for handling identity data from heterogeneous sources utilizes an Identity Data Model Broker (IDMB). The IDMB maps fields between heterogeneous data sources, served by disparate Identity Attribute Service (IdAS) context providers, to establish a normalized data format. Within an IdAS, an abstract data model, which is brokered the IDMB, is created to present a normalized view of the data from the IDMB. When a request for data is received at the IdAS, the requested data is retrieved from appropriate data sources, through respective IdAS context providers, normalized to the abstract data model, and provided to the requester by the IdAS, such that the heterogeneous data sources are shielded from the requester.

### BACKGROUND OF THE INVENTION

The present disclosure relates to the field of computers, and specifically to software. Still more specifically, the present disclosure relates to managing data.

### BRIEF SUMMARY OF THE INVENTION

A method, system and computer program product for handling identity data from heterogeneous sources utilizes an Identity Data Model Broker (IDMB). The IDMB maps fields between heterogeneous data sources, served by disparate Identity Attribute Service (IdAS) context providers, to establish a normalized data format. Within an IdAS, an abstract data model, which is brokered the IDMB, is created to present a normalized view of the data from the IDMB. When a request for data is received at the IdAS, the requested data is retrieved from appropriate data sources, through respective IdAS context providers, normalized to the abstract data model, and provided to the requester by the IdAS, such that the heterogeneous data sources are shielded from the requester.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary physical computer in which the present invention may be implemented;

FIG. 2 illustrates an Identity Data Model Broker (IDMB) used by an Identity Attribute Service (IdAS);

FIG. 3 provides exemplary detail of a mapping logic that is associated with the IDMB; and

FIG. 4 is a high-level flow-chart of exemplary steps taken by the present invention to create and utilize the IDMB with the IdAS.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java® (Java® is a trademark or registered trademark of Sun Microsystems, Inc. in the United States and other countries), Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

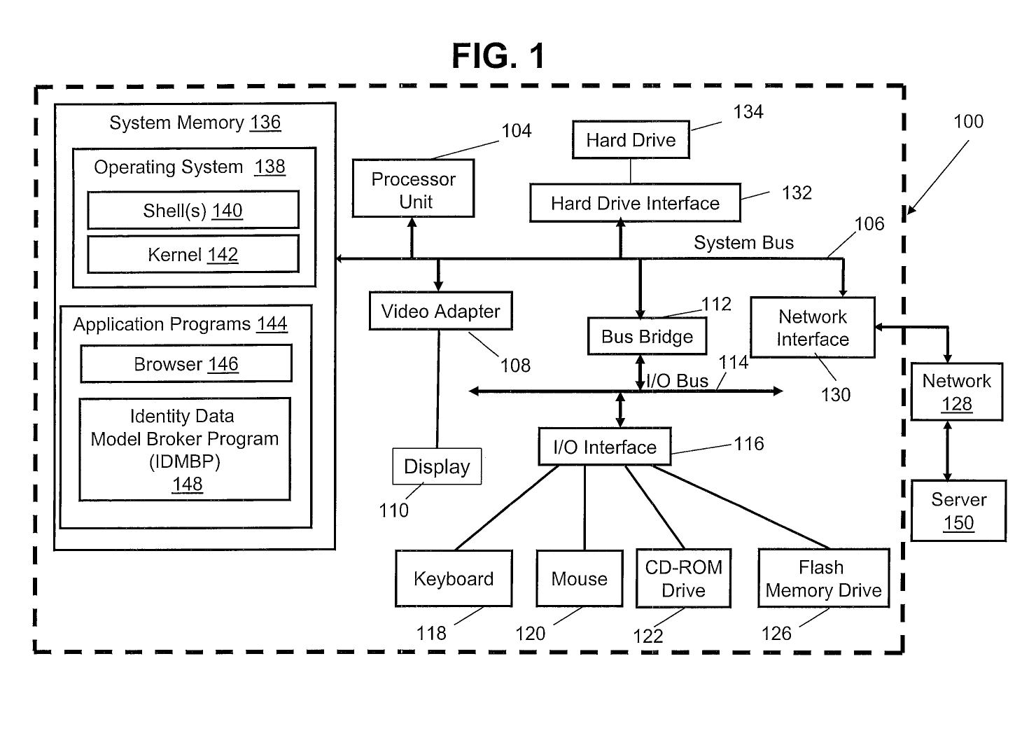

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN). Server 150 may be architecturally configured in the manner depicted for computer 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

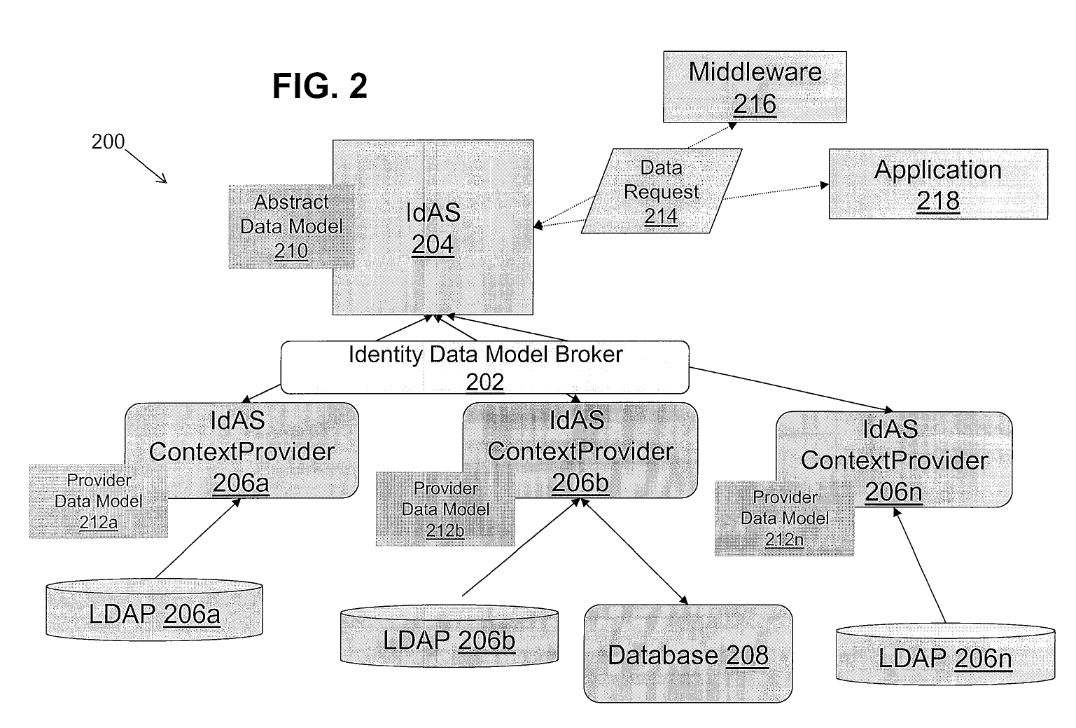

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include an Identity Data Model Broker Program (IDMBP) 148, which executes the steps described below in FIGS. 2-4, and comprises the IDMB 202 and IdAS 204 described below in FIG. 2.

In one embodiment, computer 100 is able to download IDMBP 148 from a remote service provider server 150, preferably in an “on demand” basis. In another embodiment, server 150 is able to execute IDMBP 148, thus reducing demand on hardware and software resources directly attributed to computer 100.

The hardware elements depicted in computer 100 are not intended to be exhaustive, but rather are representative to highlight essential components required by the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention. Note that the hardware architecture for service provider server 150 may be substantially similar to that shown for computer 100.

Referring now to FIG. 2, a framework 200 for utilizing an Identity Data Model Broker 202 with an Identity Attribute Service (IdAS) 204 is presented. IdAS 204 provides a virtualized view of, and access to, IdAS context providers 206a-n, wherein “n” is an integer. However, without IDMB 202, IdAS 204 is unable to harmonize the different contexts used by the IdAS context providers 206a-n. For example, assume that IdAS context provider 206a provides an Application Program Interface (API) to a Lightweight Directory Access Protocol (LDAP) resource 206a, while IdAS context provider 206n provides an API to LDAP resource 206n. Assume further that LDAP resource 206a and LDAP resource 206n both contain lists of names, but that LDAP resource 206a stores the names in the format “Last name, First name,” while LDAP resource 206n stores the names in the format “First name, Last name.” Without the mapping process provided by IDMB 202 (which maps the first and last names from that LDAP resource 206a and LDAP resource 206n into a normalized format—e.g., “Last name, First name”), IdAS 204 would be unable to correctly store and/or interpret the data from that LDAP resource 206a and LDAP resource 206n. If an IdAS context provider, such as 206b, also contains data from a non-LDAP resource, such as database 208 (e.g., a DB2 database), then the lack of harmonization between resources becomes even more pronounced. However, by “knowing” what format the different resources are in, the IDMB 202 is able to create a harmonized abstract data model 210, which is directly accessible by the IdAS 204. This harmonization can also be accomplished by harmonizing data found in provider data models 212a-n.

Again, assume that LDAP resource 206a stores the names in the format “Last name, First name” in provider data model 212a, while LDAP resource 206n stores the names in the format “First name, Last name” in provider data model 212n. IDMB 202 is able to take these disparate data formats (models) and map them into a normalized view in abstract data model 210 (e.g., “Last name, First name”).

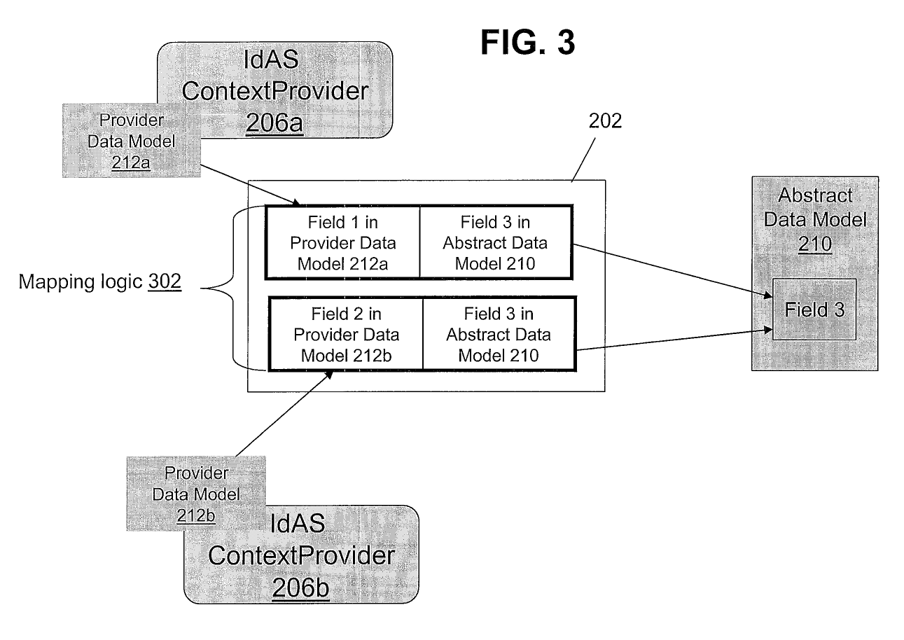

With reference now to FIG. 3, an exemplary mapping logic 302, which is associated with IDMB 202, is presented. Assume, again only for exemplary purposes and not to limit the scope of the present invention, that IdAS context provider 206a and IdAS context provider 206b both contain a list of persons, including their first names and their last names. However, the provider data model 212a (associated with IdAS context provider 206a) stores the person's last name in Field 1, while the provider data model 212b (associated with IdAS context provider 206b) stores the person's last name in Field 2. Note further, that in the example shown in FIG. 3, that abstract data model 210, which is associated with the IdAS 204, stores the person's last name in Field 3. When the person's last name is sent to the IDMB 202 from Field 1 and Field 2 of respective provider data models 202a and 202b, the mapping logic 302 maps these last names into Field 3 of the abstract data model 210 for storage therein.

Referring again now to FIG. 2, when a data request 214 is received from a middleware 216 or an application 218, the IDAS 204 is able to provide the requested data by retrieving the requested data from the sources, mapping to abstract data model 210. In one embodiment, a requester may be aware of the abstract data model 210, but is clearly shielded from the provider data model (e.g., 212a-n), thus preserving the storage format of these provider defined data models.

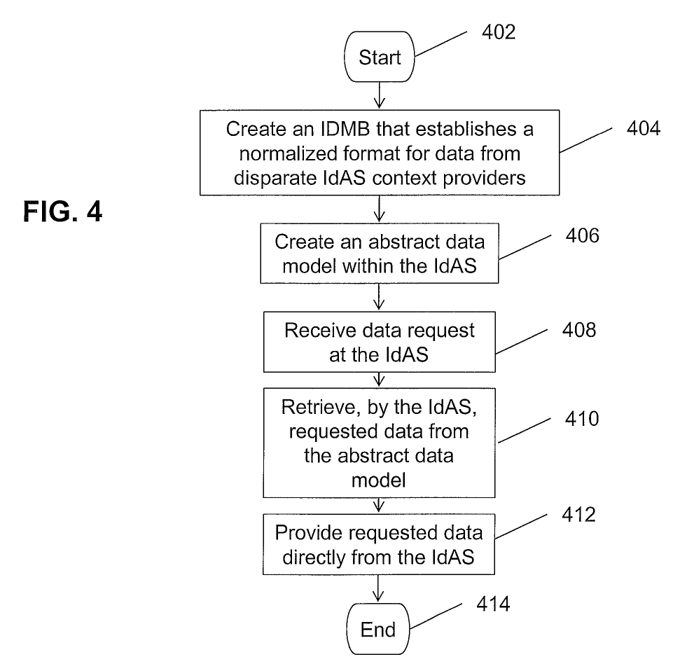

With reference now to FIG. 4, a high-level flow chart of steps taken to implement an IDMB is presented. After initiator block 402, an IDMB is created that establishes a normalized format for data from disparate IdAS context providers (block 404). These IdAS context providers may be APIs for disparate or similar formatted provider data models for disparate databases (i.e., LDAP, DB2, etc). Using the mapping feature found in the IDMB, an abstract data model is created from all of the provider data models and associated with the IdAS (block 406). Thus, the IDMB provides a protective shield between the provider data model and the abstract data models. When a request for data comes in to the IdAS (block 408), the IdAS retrieves the data from the abstract data model (block 410), thus shielding the requester from direct contact with the provider data models and providing a harmonized format (created by the mapping function of the IDMB) for all data from the disparate data sources. The retrieved data is then sent to the requester (block 412), and the process ends (terminator block 414).

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of handling data from heterogeneous data sources, the method comprising:
creating an Identity Data Model Broker (IDMB), wherein the IDMB establishes a normalized format for data from disparate Identity Attribute Service (IdAS) context providers by mapping fields between the disparate IdAS context providers to the normalized format, wherein the disparate IdAS context providers provide access to data from heterogeneous data sources;
creating, within an IdAS that communicates with the IDMB, an abstract data model, wherein the abstract data model presents a normalized view of data from the IDMB;
receiving, at the IdAS, a request for requested data from a requester, wherein the requested data is data that has been retrieved from the heterogeneous data sources and normalized to the abstract data model;
retrieving, by the IDAS, the requested data normalized to the abstract data model; and
providing, to the requester, the requested data directly from the IdAS, wherein the heterogeneous data sources are shielded from the requester.

2. The method of claim 1, wherein the normalized view presented by the abstract data model harmonizes data field organization between the disparate IdAS context providers.

3. The method of claim 2, wherein harmonized data field organization organizes an order in which data fields are stored and presented.

4. The method of claim 1, wherein the requester is a software application that is requesting the requested data.

5. The method of claim 1, wherein the requester is a software middleware that is requesting the requested data.

6. The method of claim 1, wherein the IDMB maps a relationship between data identities of objects in the disparate IdAS context providers.

7. The method of claim 1, wherein each of the disparate context providers is associated with a unique provider data model, and wherein each unique provider data model utilizes a data field order that is different from data field orders used by any other provider data model.

8. A system comprising:
a processor;
a data bus coupled to the processor;
a memory coupled to the data bus; and
a computer-usable medium embodying computer program code, the computer program code comprising instructions executable by the processor and configured for handling data from heterogeneous data sources by:
creating an Identity Data Model Broker (IDMB), wherein the IDMB establishes a normalized format for data from disparate Identity Attribute Service (IdAS) context providers by mapping fields between the disparate IdAS context providers to the normalized format, wherein the disparate IdAS context providers provide access to data from heterogeneous data sources;
creating, within an IdAS that communicates with the IDMB, an abstract data model, wherein the abstract data model presents a normalized view of data from the IDMB;
receiving, at the IdAS, a request for requested data from a requester, wherein the requested data is data that has been retrieved from the heterogeneous data sources and nonnalized to the abstract data model;
retrieving, by the IdAS, the requested data normalized to the abstract data model; and
providing, to the requester, the requested data directly from the IdAS, wherein the heterogeneous data sources are shielded from the requester.

9. The system of claim 8, wherein the normalized view presented by the abstract data model harmonizes data field organization between the disparate IdAS context providers.

10. The system of claim 9, wherein harmonized data field organization organizes an order in which data fields are stored and presented.

11. The system of claim 8, wherein the IDMB maps a relationship between data identities of objects in the disparate IdAS context providers.

12. The system of claim 8, wherein each of the disparate context providers is associated with a unique provider data model, and wherein each unique provider data model utilizes a data field order that is different from data field orders used by any other provider data model.

13. A computer program product for managing data from heterogeneous data sources, the computer program product comprising:
a computer usable medium having computer usable program code embodied therewith, the computer usable program code comprising:
computer usable program code configured for creating an Identity Data Model Broker (IDMB), wherein the IDMB establishes a normalized format for data from disparate Identity Attribute Service (IdAS) context providers by mapping fields between the disparate IdAS context providers to the normalized format, wherein the disparate IdAS context providers provide access to data from heterogeneous data sources;
computer usable program code configured for creating, within an IdAS that communicates with the IDMB, an abstract data model, wherein the abstract data model presents a normalized view of data from the IDMB;
computer usable program code configured for receiving, at the IdAS, a request for requested data from a requester, wherein the requested data is data that has been retrieved from the heterogeneous data sources and normalized to the abstract data model;
computer usable program code configured for retrieving, by the IdAS, the requested data normalized to the abstract data model; and
computer usable program code configured for providing, to the requester, the requested data directly from the IdAS, wherein the heterogeneous data sources are shielded from the requester.

14. The computer program product of claim 13, wherein the normalized view presented by the abstract data model harmonizes data field organization between the disparate IdAS context providers.

15. The computer program product of claim 14, wherein harmonized data field organization organizes an order in which data fields are stored and presented.

16. The computer program product of claim 13, wherein the IDMB maps a relationship between data identities of objects in the disparate IdAS context providers.

17. The computer program product of claim 13, wherein each of the disparate context providers is associated with a unique provider data model, and wherein each unique provider data model utilizes a data field order that is different from data field orders used by any other provider data model.

18. The computer program product of claim 13, wherein the requester is a software application that is requesting the requested data.

19. The computer program product of claim 13, wherein the computer-usable medium is a component of a remote server, and wherein the computer executable instructions are deployable to a local computer from the remote server.

20. The computer program product of claim 13, wherein the computer executable instructions are capable of being provided by a service provider to a customer on an on-demand basis.
